(19) United States
(12) Patent Application Publication
(10) Pub. No.: US 2002/0124247 A1
(43) Pub. Date: Sep. 5, 2002

(54) Polling interactive television viewers

(76) Inventor: William C. Houghton, Vienna, VA (US)

Correspondence Address: W. KARL RENNER, Fish & Richardson P.C., 601 Thirteenth Street, NW, Washington, DC, 20005, US

(21) Appl. No.: 10/090,803

(22) Filed: Mar. 6, 2002

Related U.S. Application Data
(63) Continuation-in-part of application No. 09/828,469, filed on Apr. 9, 2001.
(63) Continuation of application No. 09/365,734, filed on Aug. 3, 1999.
(63) Continuation of application No. 09/365,735, filed on Aug. 3, 1999.
(63) Continuation of application No. 09/475,391, filed on Dec. 30, 1999.
(60) Provisional application No. 60/195,248, filed on Apr. 7, 2000.
(60) Provisional application No. 60/343,184, filed on Dec. 31, 2001.

(51) Int. Cl. H04N 7/16; H04H 9/00; H04N 7/173

(52) U.S. Cl. 725/9; 725/13; 725/24

(57) ABSTRACT

Systems and techniques for polling interactive television viewers by preparing a set of polling requests, connecting to one or more set top systems of one or more interactive television viewers, sending the set of polling requests to the one or more set top systems of the one or more interactive television viewers, receiving responses to the set of polling requests, evaluating the responses to the set of polling requests, and preparing a new polling request including two or more elements selected based on the evaluation of the response to the set of polling requests.

This application is a continuation-in-part of U.S. application Ser. No. 09/828,469, filed Apr. 9, 2001, and titled “CONTEXTUAL PROGRAMMING”, which claims priority from U.S. application Ser. No. 09/365,734, filed Aug. 3, 1999; U.S. application Ser. No. 09/365,735, filed Aug. 3, 1999; U.S. application Ser. No. 09/475,391, filed Dec. 30, 1999; and U.S. Provisional Application No. 60/195,248, filed Apr. 7, 2000.

This application also claims priority from U.S. application Ser. No. 09/842,231, filed Apr. 26, 2001, titled “REAL TIME POLLING OF USERS OF A COMMUNICATIONS SYSTEM”, and from U.S. Provisional Application No. 60/343,184, filed Dec. 31, 2001, and titled “POLLING INTERACTIVE TELEVISION VIEWERS”. All of these applications are incorporated by reference in their entirety.

### TECHNICAL FIELD

This invention relates to polling of interactive television viewers.

### BACKGROUND

Web-based TV (television) systems make dual usage of conventional television sets. That is, a user of a web-based TV system can view television programming and access the Internet through the television set. A web-based system typically includes a set top box that connects to the television and translates Internet content into a TV signal.

To forecast the outcome of future events, such as, for example, a political race, pollsters randomly survey the voting population. Similarly, providers routinely solicit customer feedback to assure that customers are satisfied with a particular product or service.

Presently, some web pages allow a viewer to vote on a particular topic and to see a running tally of the results. In general, the results obtained from such an online survey may not accurately gauge an interactive television viewer's preference for one element relative to a second element in a field of elements when the field of elements becomes smaller.

### SUMMARY

In one general aspect, interactive television viewers may be polled by preparing a set of polling requests that each ask an interactive television viewer to select an element from a group of two or more elements, connecting to one or more set top systems of one or more interactive television viewers, sending the set of polling requests to the set top systems, receiving responses to the set of polling requests from one or more interactive television viewers, evaluating the responses, and preparing a new polling request including two or more elements selected based on the evaluation of the responses to the set of polling requests.

Implementations may include one or more of the following features. For example, each element appearing in the set of polling requests may be different from the every other element appearing in the set of polling requests. In another example, the polling request may include a time limit (e.g., two minutes) in which to respond, and evaluating the responses may begin upon expiration of the time limit. The time limit may be applied relative to a period beginning when the polling request is displayed. The time limit may be common to all of the interactive television viewers.

Particular content may be displayed to the interactive television viewers based on the evaluation of the responses. For example, the particular content may include a graphical user interface and/or multimedia data. Displaying the particular content may include having the set top box display content.

Implementations may use polling rules for targeting interactive television viewers.

For example, context information of interactive television viewers may be determined and the polling rules may be applied to the context information to identify targeted interactive television viewers. The context information may include the television programming being viewed by an interactive television viewer at a particular time. Determining the television programming being viewed by a viewer may include using a set top box or an electronic programming guide (“EPG”) to determine the television programming to which a television associated with the viewer is tuned.

Context information may be associated with television programming being viewed or available for delivery to the interactive television viewer. The context information associated with the television programming may be determined, for example, by a television signal received by a set top box, or by a channel identification number and/or a broadcast identifier. The polling request may be based upon context information associated with the television programming. Context information may be determined based upon a television series, an episode of the television series, an EPG identity, and/or a program content category.

The polling request may include prompting an interactive television viewer to select an element in a list of two or more elements. The polling request may include prompting the interactive television viewer to rank order a list of elements.

Implementations may include making two or more elements in a new polling request correspond to the most selected elements in two different polling requests. The set of polling requests may continue until there is one most selected element from all elements that have appeared in the polling requests. Evaluating the responses to a polling request may include determining which element in a polling request receives the most votes. Implementations also may include polling the least selected elements in two polling requests against one another. The polling request may be sent as an electronic mail message, an instant message and/or a display to overlay television programming.

In another general aspect, a set top system may participate in an interactive television poll by connecting to a host, receiving a set of polling requests, completing the polling requests, transmitting the responses to the set of polling requests, and receiving new polling requests that include elements determined by the results of the first round of polling requests. Implementations may include one or more of the features noted above.

These and other general aspects may be implemented by an apparatus and/or a computer program stored on a computer readable medium. The computer readable medium may be a disk, a client device, a host device, and/or a propagated signal.

Other features and advantages will be apparent from the following description, including the drawings, and the claims.

### DESCRIPTION OF DRAWINGS

FIG. 1 is a block diagram of a web-based TV system.

FIG. 2 is a block diagram of a set top box system.

FIGS. 3-7 are expansions of aspects the block diagram of FIG. 1.

FIG. 8 is a flow chart of a communications method that may be implemented by the systems of FIGS. 1-7.

FIG. 9 is a flow chart of a procedure for polling interactive television viewers that incorporates context information with evaluated responses to create new polls based on the received responses using the systems of FIGS. 1-7.

FIG. 10 is a diagram of one implementation of the communications method described in FIG. 8 that implements the set of polling requests as a bracket system.

Like reference symbols in the various drawings indicate like elements.

### DETAILED DESCRIPTION

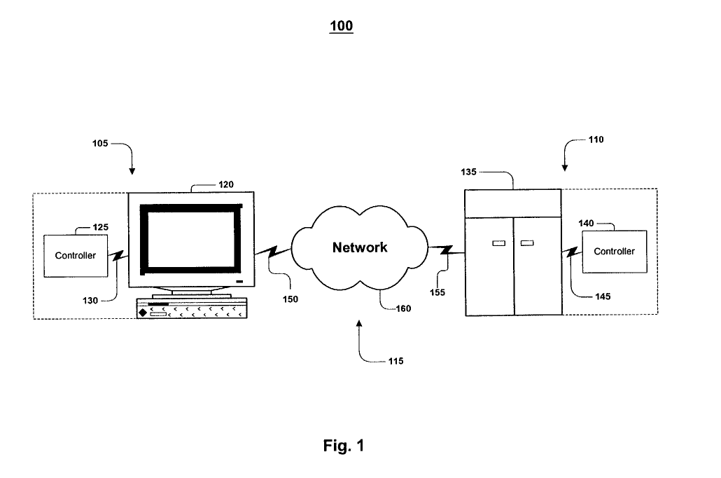

For illustrative purposes, FIGS. 1-7 describe a communications system for implementing techniques for polling interactive television viewers. For brevity, several elements in the figures described below are represented as monolithic entities. However, as would be understood by one skilled in the art, these elements each may include numerous interconnected computers and components designed to perform a set of specified operations and/or dedicated to a particular region.

Referring to FIG. 1, a communications system 100 is capable of delivering and exchanging data between a client system 105 and a host system 110 through a communications link 115. The client system 105 typically includes one or more client devices 120 and/or client controllers 125. For example, the client system 105 may include one or more general-purpose computers (e.g., personal computers), one or more special-purpose computers (e.g., devices specifically programmed to communicate with each other and/or the host system 110), or a combination of one or more general-purpose computers and one or more special-purpose computers. The client system 105 may be arranged to operate within or in concert with one or more other systems, such as for example, one or more LANs (“Local Area Networks”) and/or one or more WANs (“Wide Area Networks”).

The client device 120 is generally capable of executing instructions under the command of a client controller 125. The client device 120 is connected to the client controller 125 by a wired or wireless data pathway 130 capable of delivering data. The client device 120 and client controller 125 each typically includes one or more hardware components and/or software components. An example of a client device 120 is a general-purpose computer (e.g., a personal computer) capable of responding to and executing instructions in a defined manner. Other examples include a special-purpose computer, a workstation, a server, a device, a component, other equipment or some combination thereof capable of responding to and executing instructions. An example of client controller 125 is a software application loaded on the client device 120 for commanding and directing communications enabled by the client device 120. Other examples include a program, a piece of code, an instruction, a device, a computer, a computer system, or a combination thereof, for independently or collectively instructing the client device 120 to interact and operate as described herein. The client controller 125 may be embodied permanently or temporarily in any type of machine, component, equipment, storage medium, or propagated signal capable of providing instructions to the client device 120.

The communications link 115 typically includes a delivery network 160 making a direct or indirect communication between the client system 105 and the host system 110, irrespective of physical separation. Examples of a delivery network 160 include the Internet, the World Wide Web, WANs, LANs, analog or digital wired and wireless telephone networks (e.g. PSTN, ISDN, or XDSL), radio, television, cable, satellite, and/ or any other delivery mechanism for carrying data. The communications link 115 may include communication pathways 150, 155 that enable communications through the one or more delivery networks 160 described above. Each of the communication pathways 150, 155 may include, for example, a wired, wireless, cable or satellite communication pathway.

The host system 110 includes a host device 135 capable of executing instructions under the command and direction of a host controller 140. The host device 135 is connected to the host controller 140 by a wired or wireless data pathway 145 capable of carrying and delivering data.

The host system 110 typically includes one or more host devices 135 and/or host controllers 140. For example, the host system 110 may include one or more general-purpose computers (e.g., personal computers), one or more special-purpose computers (e.g., devices specifically programmed to communicate with each other and/or the client system 105), or a combination of one or more general-purpose computers and one or more special-purpose computers. The host system 110 may be arranged to operate within or in concert with one or more other systems, such as, for example, one or more LANs (“Local Area Networks”) and/or one or more WANs (“Wide Area Networks”). The host device 135 and host controller 140 each typically includes one or more hardware components and/or software components. An example of a host device 135 is a general-purpose computer (e.g., a personal computer) capable of responding to and executing instructions in a defined manner. Other examples include a special-purpose computer, a workstation, a server, a device, a component, other equipment or some combination thereof capable of responding to and executing instructions. An example of host controller 140 is a software application loaded on the host device 135 for commanding and directing communications enabled by the host device 135. Other examples include a program, a piece of code, an instruction, a device, a computer, a computer system, or a combination thereof, for independently or collectively instructing the host device 135 to interact and operate as described herein. The host controller 140 may be embodied permanently or temporarily in any type of machine, component, equipment, storage medium, or propagated signal capable of providing instructions to the host device 135.

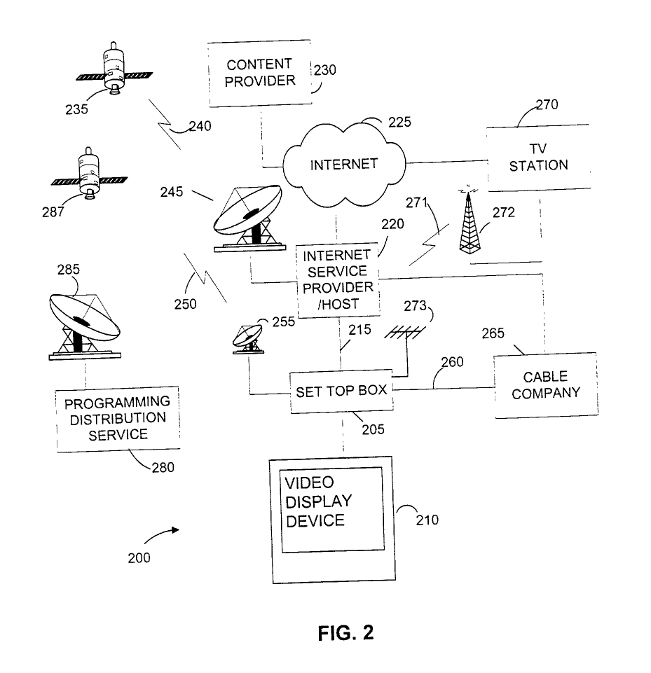

An exemplary web-based TV system 200 is shown in FIG. 2. The system 200 includes a set top box 205 connected to a video display device 210. The video display device 210 may be implemented using, for example, an analog TV, a digital TV, a high definition TV (HDTV), a video monitor, or another device capable of displaying analog and/or digital video signals. The set top box 205 gathers and manages content for presentation on the video display device 210.

The system 200 is one implementation of the communications system 100 described in FIG. 1, adapted to implement the web based TV system 200. Generally, the set top box 205 and a communications link 215 correspond to the client system 105 and communications link 115 of FIG. 1 respectively. Similarly, the Internet Service Provider/Host 220 corresponds to the host 110 in FIG. 1.

The set top box 205 gathers and manages two primary types of content: web content and TV content. Web content includes, for example, digital information that is typically, but not exclusively, communicated over a communications network. Examples of web content include a web page, an image file, an audio file, a video file, a data file, a program, an e-mail message, an instant message, and a chat session. TV content may include digital and analog information intended for presentation on a video display device that generally corresponds to established standards, such as, for example, European Telecommunications Standards Institute (ETSI), Digital Video Broadcasting (DVB), Advanced Television Systems Committee (ATSC), or European Cable Communications Association (ECCA). Examples of TV content include a broadcast TV program, a satellite TV program, a cable TV program, an output of a video player/recorder device, such as, for example, a videocassette recorder (VCR), a laser disc player, and a digital videodisk (DVD) player, and output of a video camera.

The set top box 205 may use any of a variety of known methods to gather web and TV content. The set top box 205 can be configured to receive web content from sources, such as an ultra high frequency (UHF) or a very high frequency (VHF) transmitter, a digital transmitter, a radio frequency (RF) transmitter, a satellite transmitter, a cable TV provider, and the Internet. For example, the set top box 205 can access web content over the Internet 225 through a connection to an Internet Service Provider (ISP) or host 220, such as America Online or CompuServe. The set top box 205 connects to the host 220 through a communications link 215 (e.g., a plain old telephone service (POTS), a digital subscriber line (DSL), or an integrated systems digital network (ISDN)) typically provided by a telecommunications company. Once connected to the host 220, the set top box 205 can gather web content from any number of content providers 230 connected to the Internet 225. The set top box 205 also can access web content from a satellite 235. The satellite 235 receives the web content from an uplink 240 provided by a transmitter 245 connected to, for example, the host 220. The web content is provided to the set top box 205 through a downlink 250 from the satellite 235 to a receiving dish 255. Similarly, the set top box 205 may receive web content through a cable communications link 260 connected to a cable company 205. Furthermore, web content may be inserted in the vertical blanking interval (VBI) of a TV signal (e.g. broadcast, cable, or satellite). A description of using the VBI to send web content to the set top box 205 is included in U.S. application Ser. No. 09/584,347, filed Jun. 1, 2000, and titled “ONLINE/OFFLINE TRIGGERS,” which is incorporated by reference.

The set top box 205 may receive TV content from a number of sources. For example, a TV station 270 can broadcast UHF or VHF TV signals 271 from a TV transmitter tower 272. The TV signals 271 are received by an antenna 273 connected to the set top box 205. Likewise, a TV programming distribution service 280 (e.g., Direct TV) can transmit TV content from a transmitter 285 to a satellite 287 for transmission to the receiving dish 255 connected to the set top box 205. TV content also may be provided directly to the set top box 205 from the cable company 265 by cable communications link 260.

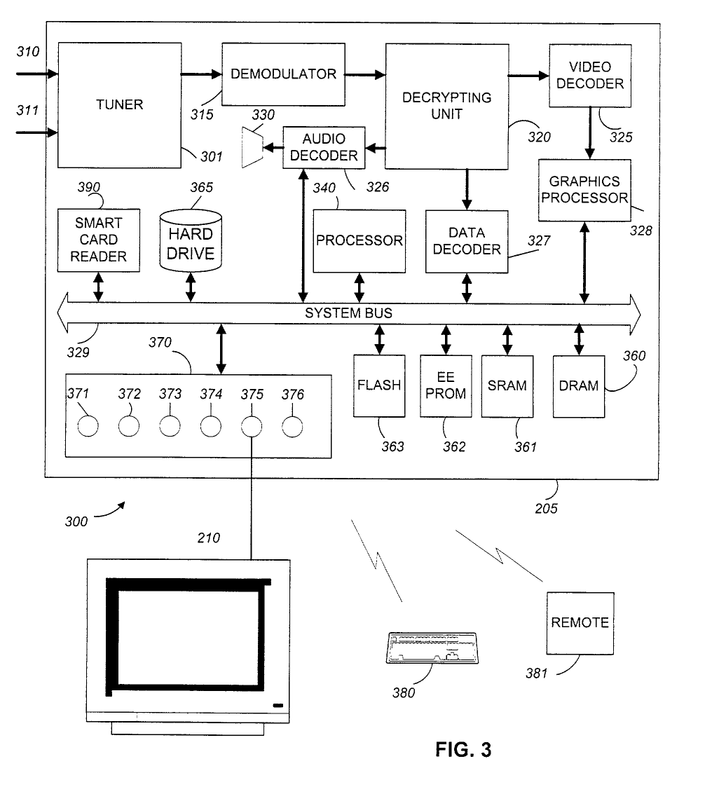

FIG. 3 shows an example of a set top box system 300 that includes a set top box 205. Generally, the set top box system 300 corresponds to implementations of the client system 105 in FIG. 1 and the set top box 205 in FIG. 2. The set top box 205 includes a tuner 301 that may receive quadrature amplitude modulation (QAM), orthogonal frequency division multiplexing (OFDM), and quadrature phase shift key (QPSK) digital TV signals 310. The digital TV signals 310 are received by the tuner 301 from, for example, cable communications link 260, or satellite dish 255. Similarly, analog TV signals 311 are provided to the tuner 301 using, for example, antenna 273. The tuner 301 may be implemented using a broadcast in-band tuner, an out-of-band tuner, and a return path tuner. In addition, the TV tuner 301 may receive TV signals 310 or 311 from a video recorder/player device (e.g., a VCR, a DVD player, or a laser disc player). A separate interface also may be provided for receiving these signals (as described in detail below). The tuner 301 isolates a physical channel from the received signal 310 or 311 and converts it to a baseband signal.

The baseband signal output from the tuner 301 is sent to a demodulator 315. The demodulator 315 samples an analog signal and converts it to a digital bit-stream (e.g., Moving Pictures Experts Group (MPEG)-2 bit stream). The data may be organized in discrete units that may be referred to as data packets. The bit-stream may include video, audio, and other data. The bit-stream is checked for errors and is forwarded to a decrypting unit 320. The decrypting unit 320 examines the packets in the bit-stream, selects particular packets, decrypts the selected packets, and forwards the decrypted packets to one or more of a video decoder 325, an audio decoder 326, or a data decoder 327.

The video decoder 325 transforms video packets into a sequence of pictures that may be displayed on the display device 210. The output from the video decoder 325 can be sent to an optional graphics processor 328 for enhanced TV and web content display. If a graphics processor is not included, the output of the video decoder 325 is sent directly to the system bus 329. The system bus 329 provides a communications path between the processor 340 and the various components of the set top box 205. An audio decoder 326 decompresses an audio bit-stream for delivery to a speaker 330 or to the system bus 329. The data decoder 327 is connected to the system bus 329 and decodes data packets for processing by the processor 340.

The processor 340 operates according to any number of operating systems available from, for example, Power TV, VxWorks, pSOSystem, Microware, Microsoft, Java, or Linux. The processor 340 provides a number of functions for the set top box 205. For example, the processor 340 initializes the set top hardware, monitors and manages hardware interrupts, and fetches data and instructions from memory. The processor 340 also processes a range of web and TV content data. Likewise, the processor 340 may execute various programs and applications stored in the memory or storage of the set top box 205, such as, for example, a browser.

The set top box 205 may include a number of memories. For example, a random access memory (RAM) can be used as a temporary storage area for data flowing between the processor 340 and set top hardware. Both dynamic RAM (DRAM) 360 and static RAM (SRAM) 361 may be used, with the DRAM 360 typically being used for interactive applications and the SRAM 361 typically being used to support time sensitive applications, such as MPEG processing. Read only memory (ROM), such as an electrically erasable programming ROM (EEPROM) 362 and a flash memory 363, also may be provided. The EEPROM 362 is used to store control programs and boot-up information for the processor 340. The flash memory 363 may be used to store programs and customer specific information. The flash memory 363 also may be used to store data downloaded from the host 220 that provide, for example, new or additional functionality to the set top box 205, temporary data or data that are continually updated. The set top box 205 also may include a large-scale memory device, such as a hard drive 365. The hard drive 365 may be used to store TV and web content, such as, for example, personal documents, favorite Internet sites, email, recorded TV content, data files, audio files, video files, programs, and other data.

The set top box 205 may include a number of input/output (I/O) interfaces 370, such as a modem 371, a high-speed multimedia interface 372, a serial interface 373, a common interface 374, a TV and VCR interface 375, and wireless interfaces 376 to devices including a remote control 380 and a wireless keyboard 381. The set top box also may include a smart card reader 390. The I/O interfaces provide a communications path between external devices and the system bus 329 to facilitate the exchange of data with the set top box 205. The set top box 205 may include one or more of any of these interfaces.

The modem 371 facilitates two-way interactivity between the set top box 205 and the host 220 or a service provider (e.g., cable company 265). Once activated, the modem 371 can send a request to a web server on the Internet 225, and may enable a viewer to download a file, to send an e-mail message, and to facilitate two-way interactive services, such as home shopping or video-on-demand.

The high-speed multimedia interface 372 allows the set top box 205 to communicate in real time with other devices, such as a camcorder, a DVD player, a laser disk player, a CD player, and a digital camera. The high-speed interface 372 may be implemented using various hardware devices, such as, for example, an IEEE 1284 parallel port, a universal serial bus, and a 10/100 Base-T (i.e., Ethernet).

The serial interface 373, which may be, for example, an RS-232 interface, provides a serial communications interface that allows the set top box 205 to exchange data with other devices, such as, for example, a printer, a computer, a personal data assistant (PDA), or an external storage device.

The common interface 374 may be included to provide a standardized interface to connect the set top box 205 with a separate hardware module, such as a PCMCIA interface.

The TV and VCR interface 375 allows the set top box 205 to communicate with the display device 210 and a video recorder/player.

Wireless interfaces 376 receive control signals from a user interface device, such as, for example, a wireless keyboard device 380 and a remote control device 381. The control signals are interpreted by processor 340 to activate and control functions of the set top box 205 and the display device 210. The remote control interface 376 can communicate with the devices 205 using RF signals, infrared signals, or otherwise.

Smart card reader 390 may read a smart card that contains, for example, identification information for authorizing access to the host 220, a service, or an e-commerce transaction.

The set top box 205 constructs or formats a display for presentation on a screen of the display device 210. The display may be constructed from web content, TV content, or a combination of both web and TV content. A browser (e.g., Liberate's TV navigator) executed by the set top processor 340 creates the display from outputs of the memories (e.g., 360, 361, and 362), the hard disk 365, the I/O interfaces 370, and/or the decoders (i.e., 325, 326, and 327). The browser can support a number of computing standards including, for example, hypertext markup language (HTML), JavaScript, and hypertext transfer protocol (HTTP).

The browser integrates web and TV content by processing, for example, a window tag. A window tag is an HTML-like tag (e.g., <IMG SRC=“TV” x=0 y=0>) that instructs the browser to place TV content received by the set top box 205 on the screen of the display device 210 at specified coordinates. By modifying a received web page to include a window tag, the browser can display the TV content in conjunction with web content in windows for each type of content. Any number of content windows may be displayed on a screen at one time. In addition, the windows may be separate or may appear to overlap each other. Web content also can be assigned HTML-like tags indicating the arrangement of the web content on the screen. The screen of the display device 210 can be modified to insert user controls, resize the TV image, and provide interactive links by altering instructions of the web content displayed by the browser.

In addition, the set top box 205 may present content that is overlaid with user interface controls or menus. The controls and menus correspond to functions performed by the set top box 205, such as, tuning channels. Interactive controls and display windows also may appear as overlaying the TV content or web content on the screen of the display device 210.

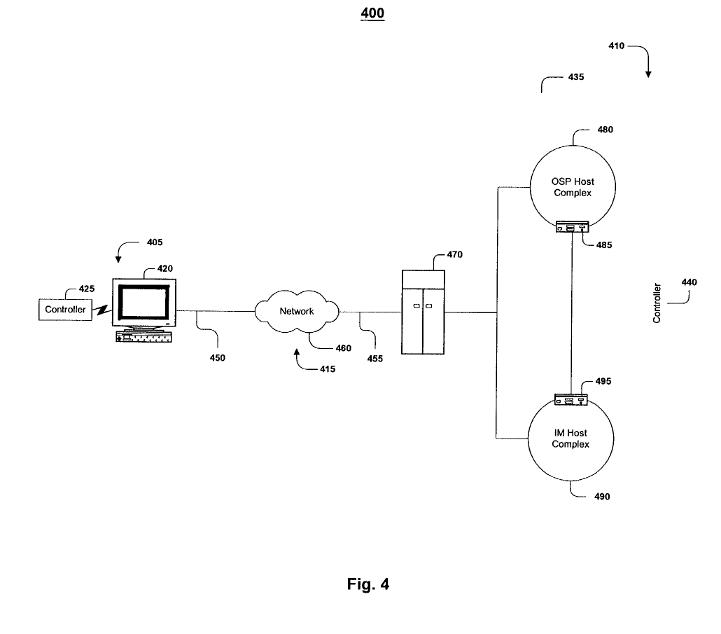

Referring to FIG. 4, a communications system 400 is capable of delivering and exchanging information between a set top system 405 and a host system 410 through a communication link 415. Set top system 405 typically includes one or more set top devices 420 and one or more set top controllers 425 for controlling the set top devices 420. Host system 410 typically includes one or more host devices 435 and one or more host controllers 440 for controlling the host devices 435. The communications link 415 may include communication pathways 450, 455 enabling communications through the one or more delivery networks 460.

Examples of each element within the communication system 400 of FIG. 4 are broadly described above with respect to FIGS. 1-3. In particular, the set top system 405 and the communications link 415 typically has attributes comparable to those described with respect to client system 105, set top box 205, set top system 300, and communications links 115 and 215 of FIGS. 1-3. Likewise, the host system 410 of FIG. 4 may have attributes comparable to and illustrates one possible implementation of the host system 110 and Internet Service Provider/Host 220 shown in FIGS. 1 and 2, respectively.

The host system 410 includes a host device 435 and a host controller 440. The host controller 440 is generally capable of transmitting instructions to any or all of the elements of the host device 435. For example, in one implementation, the host controller 440 includes one or more software applications loaded on the host device 435. However, in other implementations, as described above, the host controller 440 may include any of several other programs, machines, and devices operating independently or collectively to control the host device 435.

The host device 435 includes a login server 470 for enabling access by subscribers and routing communications between the set top system 405 and other elements of the host device 435. The host device 435 also includes various host complexes such as the depicted OSP (“Online Service Provider”) host complex 480 and IM (“Instant Messaging”) host complex 490. To enable access to these host complexes by subscribers, the set top system 405 includes communication software, such as, for example, an OSP set top application and an IM set top application. The OSP and IM communication software applications are designed to facilitate the subscriber's interactions with the respective services and, in particular, may provide access to all of the services available within the respective host complexes.

Typically, the OSP host complex 480 supports different services, such as email, discussion groups, chat, news services, and Internet access. The OSP host complex 480 is generally designed with an architecture that enables the machines within the OSP host complex 480 to communicate with each other and employs certain protocols (i.e., standards, formats, conventions, rules, and structures) to transfer data. The OSP host complex 480 ordinarily employs one or more OSP protocols and custom dialing engines to enable access by selected set top applications. The OSP host complex 480 may define one or more specific protocols for each service based on a common, underlying proprietary protocol.

The IM host complex 490 is generally independent of the OSP host complex 480, and supports instant messaging services irrespective of a subscriber's network or Internet access. Thus, the IM host complex 490 allows subscribers to send and receive instant messages, whether or not they have access to any particular ISP. The IM host complex 490 may support associated services, such as administrative matters, advertising, directory services, chat, and interest groups related to the instant messaging. The IM host complex 490 has an architecture that enables all of the machines within the IM host complex to communicate with each other. To transfer data, the IM host complex 490 employs one or more standard or exclusive IM protocols.

The host device 435 may include one or more gateways that connect and therefore link complexes, such as the OSP host complex gateway 485 and the IM host complex gateway 495. The OSP host complex gateway 485 and the IM host complex 495 gateway may directly or indirectly link the OSP host complex 480 with the IM host complex 490 through a wired or wireless pathway. Ordinarily, when used to facilitate a link between complexes, the OSP host complex gateway 485 and the IM host complex gateway 495 are privy to information regarding the protocol type anticipated by a destination complex, which enables any necessary protocol conversion to be performed incident to the transfer of data from one complex to another. For instance, the OSP host complex 480 and IM host complex 490 generally use different protocols such that transferring data between the complexes requires protocol conversion by or at the request of the OSP host complex gateway 485 and/or the IM host complex gateway 495.

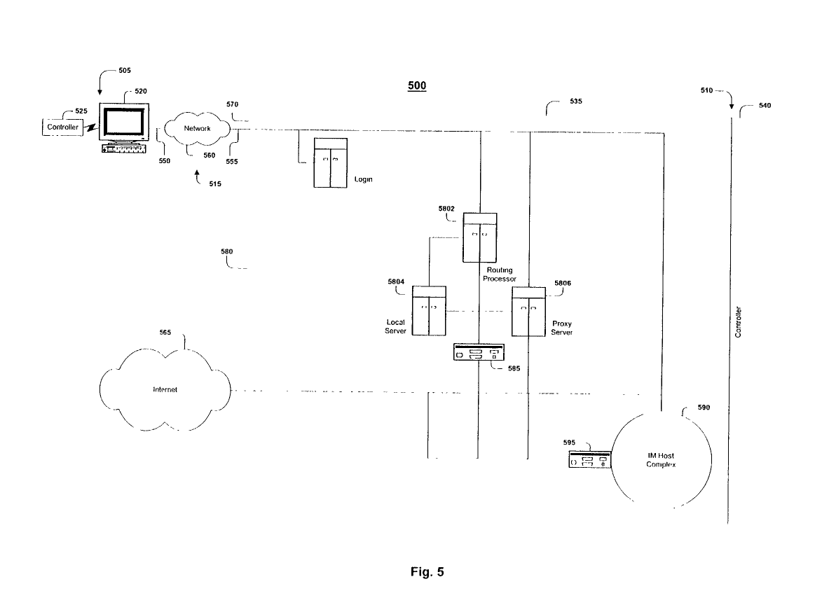

Referring to FIG. 5, a communications system 500 is capable of delivering and exchanging information between a set top system 505 and a host system 510 through a communication link 515. Set top system 505 typically includes one or more set top devices 520 and one or more set top controllers 525 for controlling the set top devices 520. Host system 510 typically includes one or more host devices 535 and one or more host controllers 540 for controlling the host devices 535. The communications link 515 may include communication pathways 550, 555 enabling communications through the one or more delivery networks 560. As shown, the set top system 505 may access the Internet 565 through the host system 510.

Examples of each element within the communication system of FIG. 5 are broadly described above with respect to FIGS. 1-4. In particular, the set top system 505 typically has attributes comparable to those described with respect to client system 105, set top box 205, and set top systems 300 and 405 of FIGS. 1-4 and the communications link 515 has attributes comparable to those described with respect to communications links 115, 215, and 415 of FIGS. 1, 2 and 4. Likewise, the host system 510 of FIG. 5 may have attributes comparable to and illustrates one possible implementation of the host systems 110, 220, and 410 shown in FIGS. 1,2 and 4. However, FIG. 5 describes an aspect of the host system 510, focusing primarily on one particular implementation of OSP host complex 580. For purposes of communicating with an OSP host complex 580, the delivery network 560 is generally a telephone network.

The set top system 505 includes a set top device 520 and a set top controller 525. The set top controller 525 is generally capable of establishing a connection to the host system 510, including the OSP host complex 580, the IM host complex 590 and/or the Internet 565. In one implementation, the set top controller 525 includes an OSP application for communicating with servers in the OSP host complex 580 using exclusive OSP protocols. The set top controller 525 also may include applications, such as an IM set top application, and/or an Internet browser application, for communicating with the IM host complex 590 and the Internet 565.

The host system 510 includes a host device 535 and a host controller 540. The host controller 540 is generally capable of transmitting instructions to any or all of the elements of the host device 535. For example, in one implementation, the host controller 540 includes one or more software applications loaded on one or more elements of the host device 535. However, in other implementations, as described above, the host controller 540 may include any of several other programs, machines, and devices operating independently or collectively to control the host device 535.

The host system 510 includes a login server 570 capable of enabling communications with and authorizing access by set top systems 505 to various elements of the host system 510, including an OSP host complex 580 and an IM host complex 590. The login server 570 may implement one or more authorization procedures to enable simultaneous access to the OSP host complex 580 and the IM host complex 590. The OSP host complex 580 and the IM host complex 590 are connected through one or more OSP host complex gateways 585 and one or more IM host complex gateways 595. Each OSP host complex gateway 585 and IM host complex gateway 595 may perform any protocol conversions necessary to enable communication between the OSP host complex 580, the IM host complex 590, and the Internet 565.

The OSP host complex 580 supports a set of services from one or more servers located internal to and external from the OSP host complex 580. Servers external to the OSP host complex 580 generally may be viewed as existing on the Internet 565. Servers internal to the OSP complex 580 may be arranged in one or more configurations. For example, servers may be arranged in centralized or localized clusters in order to distribute servers and subscribers within the OSP host complex 580.

In the implementation of FIG. 5, the OSP host complex 580 includes a routing processor 5802. In general, the routing processor 5802 will examine an address field of a data request, use a mapping table to determine the appropriate destination for the data request, and direct the data request to the appropriate destination. In a packet-based implementation, the set top system 505 may generate information requests, convert the requests into data packets, sequence the data packets, perform error checking and other packet-switching techniques, and transmit the data packets to the routing processor 5802. Upon receiving data packets from the set top system 505, the routing processor 5802 may directly or indirectly route the data packets to a specified destination within or outside of the OSP host complex 580. For example, in the event that a data request from the set top system 505 can be satisfied locally, the routing processor 5802 may direct the data request to a local server 5804. In the event that the data request cannot be satisfied locally, the routing processor 5802 may direct the data request externally to the Internet 565 or the IM host complex 590 through the gateway 585.

The OSP host complex 580 also includes a proxy server 5806 for directing data requests and/or otherwise facilitating communication between the set top system 505 and the Internet 565 through. The proxy server 5802 may include an IP (“Internet Protocol”) tunnel for converting data from OSP protocol into standard Internet protocol and transmitting the data to the Internet 565. The IP tunnel also converts data received from the Internet in the standard Internet protocol back into the OSP protocol and sends the converted data to the routing processor 5802 for delivery back to the set top system 505.

The proxy server 5806 also may allow the set top system 505 to use standard Internet protocols and formatting to access the OSP host complex 580 and the Internet 565. For example, the subscriber can use an OSP TV set top application having an embedded browser application installed on the set top system 505 to generate a request in standard Internet protocol, such as HTTP (“HyperText Transport Protocol”). In a packet-based implementation, data packets may be encapsulated inside a standard Internet tunneling protocol, such as, for example, UDP (“User Datagram Protocol”) and routed to the proxy server 5806. The proxy server 5806 may include a L2TP (“Layer Two Tunneling Protocol”) tunnel capable of establishing a point-to-point protocol (PPP) session with the set top system 505.

The proxy server 5806 also may act as a buffer between the set top system 505 and the Internet 565, and may implement content filtering and time saving techniques. For example, the proxy server 5806 can check parental controls settings of the set top system 505 and request and transmit content from the Internet 565 according to the parental control settings. In addition, the proxy server 5806 may include one or more caches for storing frequently accessed information. If requested data are determined to be stored in the caches, the proxy server 5806 may send the information to the set top system 505 from the caches and avoid the need to access the Internet 565.

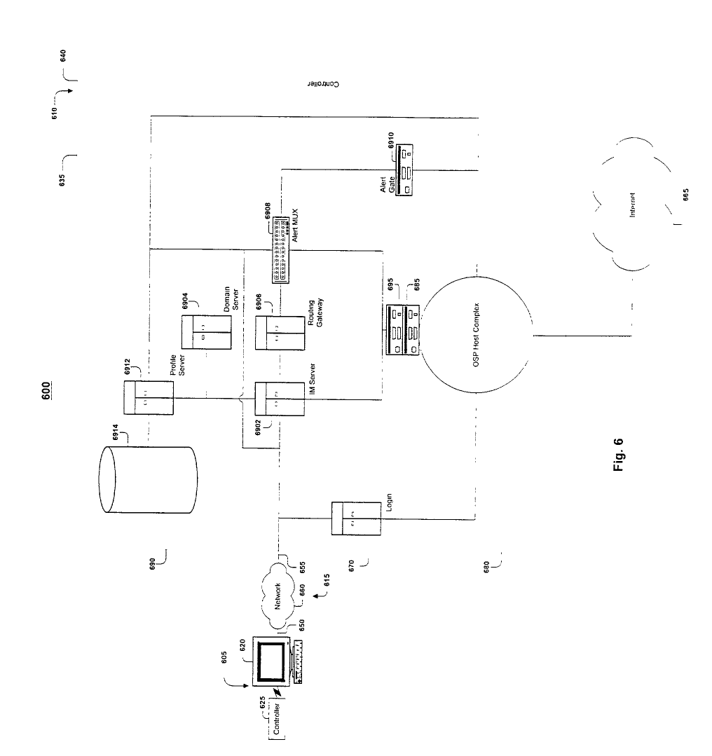

Referring to FIG. 6, a communications system 600 is capable of delivering and exchanging information between a set top system 605 and a host system 610 through a communication link 615. Set top system 605 typically includes one or more set top devices 620 and one or more set top controllers 625 for controlling the set top devices 620. Host system 610 typically includes one or more host devices 635 and one or more host controllers 640 for controlling the host devices 635. The communications link 615 may include communication pathways 650, 655 enabling communications through the one or more delivery networks 660. As shown, the set top system 605 may access the Internet 665 through the host system 610.

Examples of each element within the communication system of FIG. 6 are broadly described above with respect to FIGS. 1-5. In particular, the set top system 605 typically has attributes comparable to those described with respect to client system 105, set top box 205, and set top systems 300, 405, and 505 of FIGS. 1-5 and the communications link 615 typically has attributes comparable to those described with respect to communications links 115, 215, 415, and 515 of FIGS. 1-5. Likewise, the host system 610 of FIG. 6 may have attributes comparable to and illustrates one possible embodiment of the host systems 110, 215, 410, and 510 shown in FIGS. 1, 2, 4 and 5. However, FIG. 6 describes an aspect of the host system 610, focusing primarily on one particular implementation of IM host complex 690. For purposes of communicating with the IM host complex 690, the delivery network 660 is generally a telephone network.

The set top system 605 includes a set top device 620 and a set top controller 625. The set top controller 625 is generally capable of establishing a connection to the host system 610, including the OSP host complex 680, the IM host complex 690 and/or the Internet 665. In one implementation, the set top controller 625 includes an IM application for communicating with servers in the IM host complex 690 utilizing exclusive IM protocols. The set top controller 625 also may include applications, such as an OSP set top application, and/or an Internet browser application for communicating with the OSP host complex 680 and the Internet 665, respectively.

The host system 610 includes a host device 635 and a host controller 640. The host controller 640 is generally capable of transmitting instructions to any or all of the elements of the host device 635. For example, in one implementation, the host controller 640 includes one or more software applications loaded on one or more elements of the host device 635. However, in other implementations, as described above, the host controller 640 may include any of several other programs, machines, and devices operating independently or collectively to control the host device 635.

The host system 610 includes a login server 670 capable of enabling communications with and authorizing access by set top systems 605 to various elements of the host system 610, including an OSP host complex 680 and an IM host complex 690. The login server 670 may implement one or more authorization procedures to enable simultaneous access to the OSP host complex 680 and the IM host complex 690. The OSP host complex 680 and the IM host complex 690 are connected through one or more OSP host complex gateways 685 and one or more IM host complex gateways 695. Each OSP host complex gateway 685 and IM host complex gateway 695 may perform any protocol conversions necessary to enable communication between the OSP host complex 680, the IM host complex 690, and the Internet 665.

To access the IM host complex 690 to begin an instant messaging session, the set top system 605 establishes a connection to the login server 670. The login server 670 typically determines whether the particular subscriber is authorized to access the IM host complex 690 by verifying a subscriber identification and password. If the subscriber is authorized to access the IM host complex 690, the login server 670 employs a hashing technique on the subscriber's screen name to identify a particular IM server 6902 for use during the subscriber's session. The login server 670 provides the set top system 605 with the IP address of the particular IM server 6902, gives the set top system 605 an encrypted key (i.e., a cookie), and breaks the connection. The set top system 605 then uses the IP address to establish a connection to the particular IM server 6902 through the communications link 615, and obtains access to that IM server 6902 using the encrypted key. Typically, the set top system 605 will be equipped with a Winsock API (“Application Programming Interface”) that enables the set top system 605 to establish an open TCP connection to the IM server 6902.

Once a connection to the IM server 6902 has been established, the set top system 605 may directly or indirectly transmit data to and access content from the IM server 6902 and one or more associated domain servers 6904. The IM server 6902 supports the fundamental instant messaging services and the domain servers 6904 may support associated services, such as, for example, administrative matters, directory services, chat and interest groups. In general, the purpose of the domain servers 6904 is to lighten the load placed on the IM server 6902 by assuming responsibility for some of the services within the IM host complex 690. By accessing the IM server 6902 and/or the domain server 6904, a subscriber can use the IM set top application to view whether particular subscribers (“buddies”) are online, exchange instant messages with particular subscribers, participate in group chat rooms, trade files such as pictures, invitations or documents, find other subscribers with similar interests, get customized news and stock quotes, and search the Web.

In the implementation of FIG. 6, the IM server 6902 is directly or indirectly connected to a routing gateway 6906. The routing gateway 6906 facilitates the connection between the IM server 6902 and one or more alert multiplexors 6908, for example, by serving as a link minimization tool or hub to connect several IM servers to several alert multiplexors. In general, an alert multiplexor 6908 maintains a record of alerts and subscribers registered to receive the alerts.

Once the set top system 605 is connected to the alert multiplexor 6908, a subscriber can register for and/or receive one or more types of alerts. The connection pathway between the set top system 605 and the alert multiplexor 6908 is determined by employing another hashing technique at the IM server 6902 to identify the particular alert multiplexor 6908 to be used for the subscriber's session. Once the particular multiplexor 6908 has been identified, the IM server 6902 provides the set top system 605 with the IP address of the particular alert multiplexor 6908 and gives the set top system 605 an encrypted key (i.e., a cookie). The set top system 605 then uses the IP address to connect to the particular alert multiplexor 6908 through the communication link 615 and obtains access to the alert multiplexor 6908 using the encrypted key.

The alert multiplexor 6908 is connected to an alert gate 6910 that, like the IM host complex gateway 695, is capable of performing the necessary protocol conversions to form a bridge to the OSP host complex 680. The alert gate 6910 is the interface between the IM host complex 690 and the physical servers, such as servers in the OSP host complex 680, where state changes are occurring. In general, the information regarding state changes will be gathered and used by the IM host complex 690. However, the alert multiplexor 6908 also may communicate with the OSP host complex 680 through the IM gateway 695, for example, to provide the servers and subscribers of the OSP host complex 680 with certain information gathered from the alert gate 6910.

The alert gate 6910 can detect an alert feed corresponding to a particular type of alert. The alert gate 6910 may include a piece of code (alert receive code) capable of interacting with another piece of code (alert broadcast code) on the physical server where a state change occurs. In general, the alert receive code installed on the alert gate 6910 instructs the alert broadcast code installed on the physical server to send an alert feed to the alert gate 6910 upon the occurrence of a particular state change. Upon detecting an alert feed, the alert gate 6910 contacts the alert multiplexor 6908, which in turn, informs the set top system 605 of the detected alert feed.

In the implementation of FIG. 6, the IM host complex 690 also includes a subscriber profile server 6912 connected to a database 6914 for storing large amounts of subscriber profile data. The subscriber profile server 6912 may be used to enter, retrieve, edit, manipulate, or otherwise process subscriber profile data. In one implementation, a subscriber's profile data includes, for example, the subscriber's buddy list, alert preferences, designated stocks, identified interests, and geographic location. The subscriber may enter, edit and/or delete profile data using an installed IM set top application on the set top system 605 to interact with the subscriber profile server 6912.

Because the subscriber's data is stored in the IM host complex 690, the subscriber does not have to reenter or update such information in the event that the subscriber accesses the IM host complex 690 using new or a different set top system 605. Accordingly, when a subscriber accesses the IM host complex 690, the IM server 6902 can instruct the subscriber profile server 6912 to retrieve the subscriber's profile data from the database 6914 and to provide, for example, the subscriber's buddy list to the IM server 6902 and the subscriber's alert preferences to the alert multiplexor 6908. The subscriber profile server 6912 also may communicate with other servers in the OSP host complex 690 to share subscriber profile data with other services. Alternatively, user profile data may be saved locally on the set top device 605.

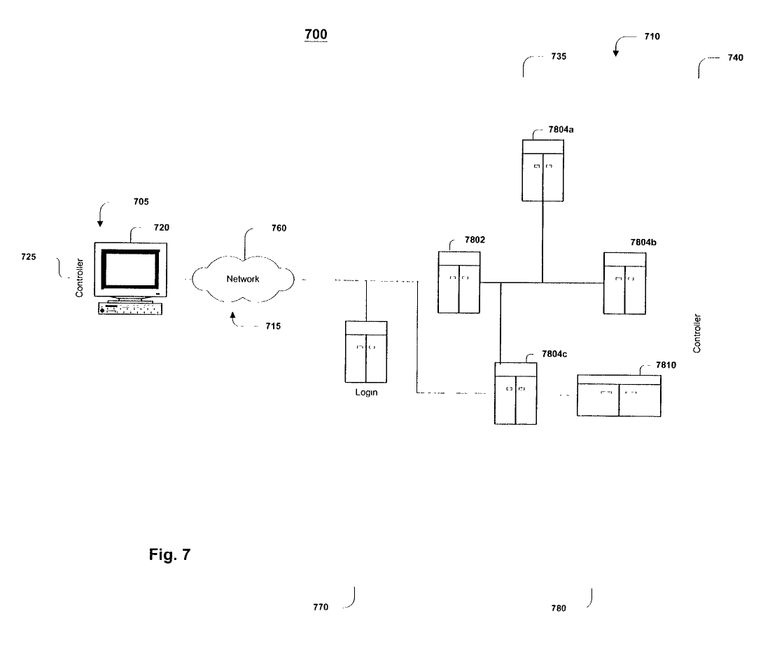

Referring to FIG. 7, a communications system 700 is capable of delivering and exchanging information between a set top system 705 and a host system 710 through a communication link 715. Set top system 705 typically includes one or more set top devices 720 and one or more set top controllers 725 for controlling the set top devices 720. Host system 710 typically includes one or more host devices 735 and one or more host controllers 740 for controlling the host devices 735. The communication link may include communication pathways 750, 755 enabling communications through the one or more delivery networks 760. The network 760 may be any known or described delivery network including, but not limited, to a telephone network and/or the Internet.

Examples of each element within the communication system of FIG. 7 are broadly described above with respect to FIGS. 1-6. In particular, the set top system 705 typically has attributes comparable to those described with respect to client system 105, set top box 205, and set top systems 300, 405, 505 and 605 of FIGS. 1-6 and the communications link 715 typically has attributes comparable to those described with respect to communications links 115, 215, 415, 515 and 615 of FIGS. 1-6. Likewise, the host system 710 of FIG. 7 may have attributes comparable to and illustrates one possible implementation of the host systems 110, 220, 410, 510 and 610 shown in FIGS. 1, 2 and 4-6. FIG. 7 describes an aspect of the host system 710, focusing primarily on one particular implementation of the host device 735.

The set top system 705 includes a set top device 720 and a set top controller 725. The set top controller 725 is generally capable of establishing a connection to the host system 710 through the delivery network 715. In one implementation, the set top controller 725 includes one or more applications, such as an IM application, an OSP application, and/or an Internet browser application.

The host system 710 includes a host device 735 and a host controller 740. The host controller 740 is generally capable of transmitting instructions to any or all of the elements of the host device 735. For example, in one implementation, the host controller 740 includes one or more software applications loaded on one or more elements of the host device 735. However, in other implementations, as described above, the host controller 740 may include any of several other programs, machines, and devices operating independently or collectively to control the host device 735. The host system 710 also includes a login server 770 capable of enabling communications with and authorizing access by set top systems 705 to various elements of the host system 710 including the OSP host complex 780.

As shown in FIG. 7, the OSP host complex 780 of the host device 735 includes a control server 7810 configured to transmit and receive data in response to certain conditions and/or commands. The host device 735 also includes a routing processor 7802 configured to directly or indirectly route data packets to a specified destination within or outside of the OSP host complex 780, such as, for example to one or more local servers 7804a, 7804b, and 7804c. The local servers, alone or collectively, are configured to provide certain online services to users associated of the OSP host complex 780. A more complete understanding will be provided by the communications methods described below.

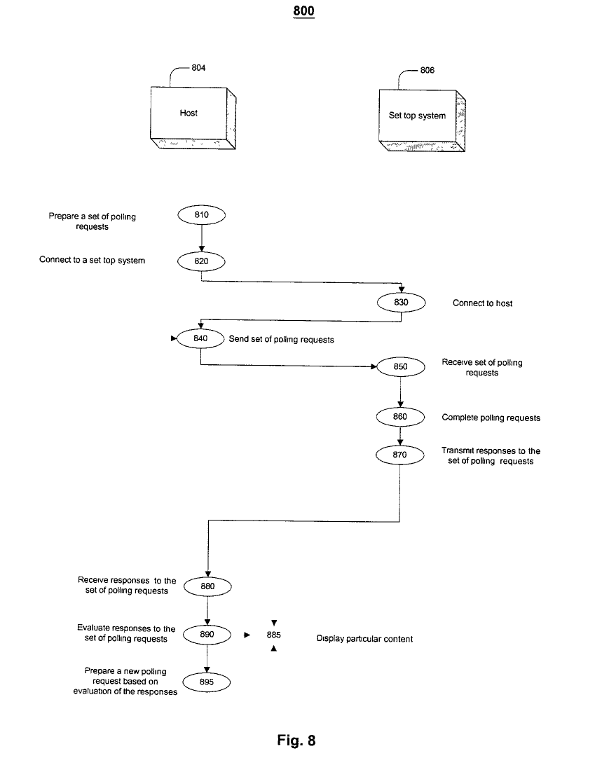

Referring to FIG. 8, a host 804 and a set top system 806 interact according to procedure 800 to poll interactive television viewers. The procedure 800 may be implemented by any type of hardware, software, device, computer, computer system, equipment, component, program, application, code, storage medium, or propagated signal.

Examples of each element of FIG. 8 are broadly described above with respect to FIGS. 1-7. In particular, set top system 806 typically has attributes comparable to those described with respect to client system 105, set top box 205 and set top systems 300, 405, 505, 605, and 705 of FIGS. 1-7. The host 804 typically has attributes comparable to those described above with respect to host systems 110, 220, 410, 510, 610 and 710 shown in FIGS. 1, 2 and 4-7. The host 804 and the set top system 806 may be directly or indirectly interconnected through a known or described delivery network.

Initially, the host 804 prepares a set of polling requests (step 810). Preparing a polling request typically involves preparing an electronic ballot for transmission to one or more interactive television viewers. Generally, the polling request includes two or more elements for which the user may make a selection of preference. Preparing a set of polling requests involves creating a rule base such that the elements selected in two or more polling requests may subsequently be polled against one another in a subsequent polling request. For example, if a first interactive television viewer selected element A in response to a polling request allowing selection between elements A and B, and a second interactive television viewer selected element C in response to a polling request allowing selection between elements C and D, a subsequent polling request may allow selection between elements A and C.

Implementations may include designating polling rules for targeting interactive television viewers. For example, context information may be determined for one or more interactive television viewers. The context information may be applied to the polling rules to identify targeted interactive television viewers, and create a set of polling requests designed to poll identified interactive television viewers. For example, the targeting rules may desire that a certain demographic participate in a specified set of polling requests. The set of polling requests may then target those interactive television viewers whose context information indicates the designated demographic profile.

Determining context information may include determining the television programming being viewed by a user at a particular time. The television programming being viewed may be determined using a set top box (e.g., set top system 806), and/or an EPG. Implementations also may include determining context information associated with television programming available for delivery to the interactive television viewer. This may be determined using the television signal received at a set top box, a channel identification number, and/or a broadcaster identifier.

Context information is further described in U.S. Application Ser. No. 09/828,469, filed Apr. 29, 2001, and titled “CONTEXTUAL PROGRAMMING,” which is incorporated by reference. Context information also includes electronic pages served from servers within an online service provider host complex and/or the Internet. Authors, such as, for example, broadcasters and other interested parties (e.g., business partners, venders, promoters) and/or their agents can create electronic pages using HTML, JavaScript, and/or other languages. Electronic pages may be published and accessible through online service providers, the World Wide Web, and/or the Internet.

Preparing a set of polling requests may include determining context information based on a television show, an episode of a television show, an EPG identity, and/or a program content category that is being viewed or available for delivery.

Next, a connection is established to the set top system 806 (step 820). Establishing a connection may include determining that the device is available to receive a polling request. Implementations may include establishing a connection to the device to determine context information. For example, some of the methods of determining context information may be determined from establishing this connection (e.g., examining the channel identification number being viewed). Thus, although preparing the set of polling requests is depicted as occurring before establishing the connection, implementations may include establishing the connection before preparing the set of polling requests.

The set top system 806 then establishes a connection to the host 804 (step 830). Although FIG. 8 depicts host 804 initiating the connection, a set top system 806 may initiate the connection. For example, a set top system 806 may periodically communicate with the host 804 to submit contextual updates.

The host 804 sends the set of polling requests to the set top system 806 (step 840). Generally, sending the polling request involves transmitting a polling request with two or more elements from which an interactive television viewer may select an element. Implementations may include transmitting more than one polling request per polling transmission. For example, a transmission may include eight polling requests, the “winners” of which will subsequently be polled against one another.

Implementations of sending a polling request may include sending an electronic mail message, an instant message, or a display to overlay the television programming. For example, an interactive television viewer may be viewing television programming with several online applications available around the displayed television programming. The host 804 may detect which applications are available and/or preferred and send a polling request to interface with that application. For example, the user may receive an instant message with the polling request.

The set top system 806 receives the set of polling requests (step 850), and the interactive television viewer using the set top system 806 completes the polling requests (step 860). Generally, completing a polling request involves using an input device (e.g., the input devices described in FIG. 2) to indicate the response of the interactive television viewer.

Implementations of the polling request may include presenting one element in a polling request and allowing a user to register multiple inputs to indicate an “applause” level. The counts of inputs per element may be compared against one another to determine a most selected element.

An interactive television viewer may be allowed to rank order a list of elements to determine preferences. For example, a viewer may be asked to rank relevance of features appearing in a television episode.

A polling request may include more than two elements per polling request. For example, an interactive television viewer may be asked to select a favorite song in a list of five songs.

The set top system 806 transmits the responses to the polling requests to the host 804 (step 870). Transmitting the responses to the polling request may include transmitting responses of multiple polling requests to the host 804.

The host 804 receives the responses to the set of polling requests (step 880). Polling requests and their associated replies may be sent or received in an asynchronous manner. For example, a polling request may be sent in an electronic mail message and the associated reply may be sent as a proprietary submission.

The host 804 evaluates the responses to the set of polling requests (step 890). Generally, evaluating the responses includes compiling the results (e.g., counting, summarizing) of all of the received responses to the polling requests. Evaluating the responses may include using sampling techniques to determine results on a subset of received responses. For example, an OSP may desire an instantaneous response to determine the next content piece and may use sampling techniques that enable the OSP to decide a course of action (e.g., select content to generate) in a timelier manner.

Implementations may include evaluating the responses after a time limit has elapsed. For example, all ballots may be tallied after two minutes have elapsed. The period against which the time limit is applied may begin when the ballot is initially displayed. The time limit may be common to all interactive television viewers. For example, all interactive television viewers may be polled in the opening sequence of a news program to determine which features will be broadcast. Interactive television viewers may have one minute to respond to the polling requests to “vote” on features that will be broadcast in that segment. Other implementations of evaluating the responses may use techniques that gauge the breadth of support, or calculate the winner through aggregating popular, but less selected items. For example, one element may advance to the next round when it is ranked as a most selected relative to the other elements in polling request featuring ranking. However, if an element received widespread support with second place votes, the element with the second place votes may advance over an element with more first place votes, but shallower support across second and third place votes.

Other implementations may use other formulas to determine which elements advance. For example, anomalous selections may be disregarded. In another example, if an element was previously selected with fewer participants, but increased participation suggests that another element would be more selected, the selection may be skewed to compensate for recent arrivals.

The host 804 prepares a new polling request based on the evaluation of the responses (step 895). For example, a host 804 may create a system of brackets whereby the most selected element in one polling request faces the most selected element in a second polling request. These subsequent rounds of balloting may continue to provide a relative ranking of elements, depending on the configuration of the set of polling requests.

Implementations may include sending additional polling requests. This may include several cycles of completing steps 840-895.

Implementations may include displaying particular content based on the responses to the polling request (step 885). For example, a GUI (“graphical user interface”) or multimedia data (e.g., music, video, slide show) may be displayed based on the responses to one or more polling requests. In one implementation, a set of polling requests may determine a most popular song to be “broadcast.” Other implementations may include determining a TV show or episode to be broadcast, or features within a show to be broadcast.

Generally, displaying particular content may be performed after receiving the responses to the polling requests (step 880), after the responses have been evaluated (step 890), or after future elements in new polling requests are determined (step 895). For example, after future elements in new polling requests are determined, the content displayed may include the elements in those new ballots.

Implementations may include coupling the determination of context information with content to be displayed. For example, context information may be determined for an online user. Based on the responses to the set of online polls, the context information may select one or more pieces of content to be displayed. For example, a user may be participating in an interactive game show against other interactive television viewers in their target demographic. Interactive television viewers in that demographic may be asked questions appropriate to their demographic (e.g., a younger audience may be quizzed on questions about television shows popular with a younger audience).

Implementations of displaying the content may include having the set top system 806 create an “overlay” on a television that displays the polling request as well as content based on the responses. For example, the set top box may display the responses of the polling request for all users by percentage of votes cast per element. Other implementations may allow additional interactive applications to be displayed.

Other techniques of displaying content may include the use of off screen, or side-screen displays. For example, when a question appears, the display may be split in half, with half of the screen being used to display the polling requests and the other screen being used to display a television program. In another example, the view of the television programming may be switched for a display of a polling request.

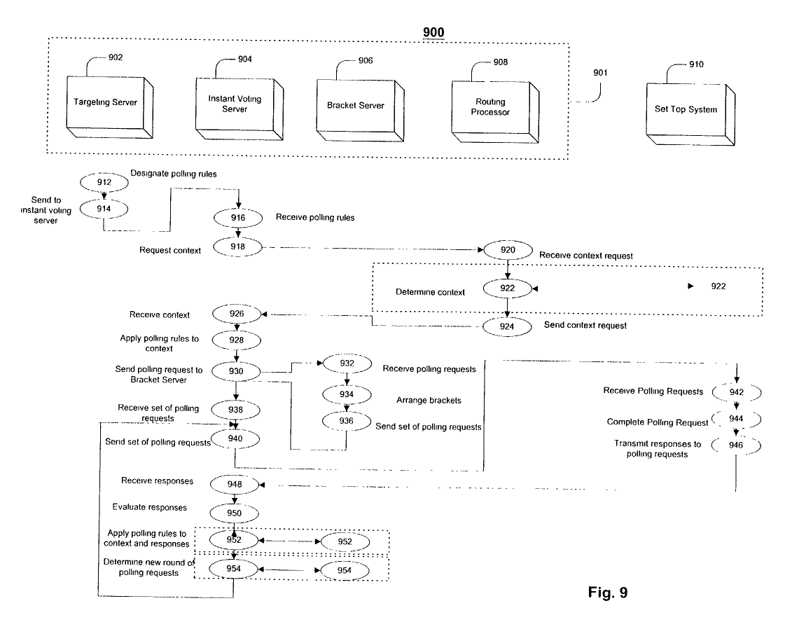

Referring to FIG. 9, a host 901 and a set top system 910 interact according to a procedure 900 to poll interactive television viewers with a set of polling requests that incorporate context information with responses from users to determine relative preferences of users. The procedure 900 may be implemented by any type of hardware, software, device, computer, computer system, equipment, component, program, application, code, storage medium, or propagated signal.

As shown in FIG. 9, the host 901 includes a targeting server 902, an instant voting server 904, a bracket server 906, and a routing processor 908. In one implementation, and with reference to FIG. 6, the targeting server 902 and bracket server 906 are control servers 6810, the instant voting server 904 is a local server 6804c, and the routing processor 908 is a routing processor 6802. Initially, the targeting server 902 designates polling rules (step 912). The targeting server 902 may perform such designation in response to user input and/or commands from another server in the pod 6810a or the OSP host complex 680. The polling rules may include, but are not limited to, the polling issue or question, the target audience or group, and the time limit for answering.

The targeting server transmits the polling rules to the instant voting server (step 914). The instant voting server receives the polling rules (step 916). With reference to FIG. 6, each instant voting server may be a local server 6804a dedicated for serving certain users. It is understood, however, that each instant voting server may represent a network of interconnected instant voting servers.

The instant voting server 904 requests context information from the routing processor 908 (step 918). The routing processor 908 receives the request (step 920).

The routing processor determines context information (step 922). Aspects of determining the context may include using information available to the set top system 910, as shown by the box indicating that determining the context may occur on both the routing processor 908 and the set top system 910. The routing processor 908 then sends the context information to the instant voting server 904 (step 924). The instant voting server 904 receives the context information (step 926) and applies the polling rules to the context information (step 928). Generally, applying the polling rules to the context information creates a list of set top systems that will be sent polling requests.

The instant voting server 904 then sends the polling request to the bracket server 906 (step 930). The bracket server 906 receives the polling request (step 932) and arranges the brackets for the polling request (step 934). The bracket server 906 generally structures the polling request so that the most selected elements in earlier polling requests are employed as elements in later polling requests.

Arranging the brackets involves structuring a rule base that configures future polling requests based on the responses sent in by users. For example, the bracket server 906 may continue to poll popular elements against one another in order to determine relative popularities of elements. Implementations may include using a series of rules in which the future elements are automatically paired up against elements from other brackets and the set of possible elements that are available in any new polling request are determined in advance. For example, the “winner” of a first polling request may automatically face the “winner” of a second polling request. Implementations also may include dynamically configuring brackets for subsequent rounds based on responses in earlier rounds. For example, after a round of eight polling requests, responses may indicate users responded strongly to the first and second polling requests. The subsequent brackets may be arranged so that the elements emerging from these polling requests would only be polled against one another in the final, third round polling request.

The bracket server 906 then sends the set of polling requests to the instant voting server (step 936). Sending the set of polling requests may include sending parameters to the instant voting server 904 indicating the manner in which polling requests should be transmitted. For example, the bracket server 906 may direct the instant voting server 904 to send polling requests 1-8 as one round of polling requests.

The instant voting server 904 receives the set of polling requests (step 938). The instant voting server then sends the set of polling requests to the set top system 910 (step 940). Sending the set of polling requests may include sending parameters indicating which of the polling requests that have been preloaded to the set top system should be displayed. For example, a set top system may receive several polling requests in advance by using VBI. The polling request may direct the set top system 910 to display polling requests 1, 5, and 10.

The set top system 942 receives the polling request (step 942). The user then completes the polling request (step 944). The response to the polling request is then transmitted to the instant voting server (step 946).

The instant voting server receives the responses (step 948) and tallies them (step 950). Implementations of evaluating the responses may include aggregating the responses from multiple instant voting servers. For example, several instant voting servers may send their responses to the bracket server 906, which then compiles the overall results.

The instant voting server applies the polling rules to context information and responses to questions (step 952). As indicated in FIG. 9, applying the polling rules to context and responses may be performed on several systems in the host 901. With the polling rules applied to the context and responses, a new round of polling requests is determined (step 954). For example, after a first round of polling requests, the responses may indicate that certain users have certain preferences. Subsequent rounds may include polling requests that include elements targeted for the user based on the preferences expressed in the first round.

As is indicated by the arrow returning to step 940, a new set of polling requests may be sent to the user.

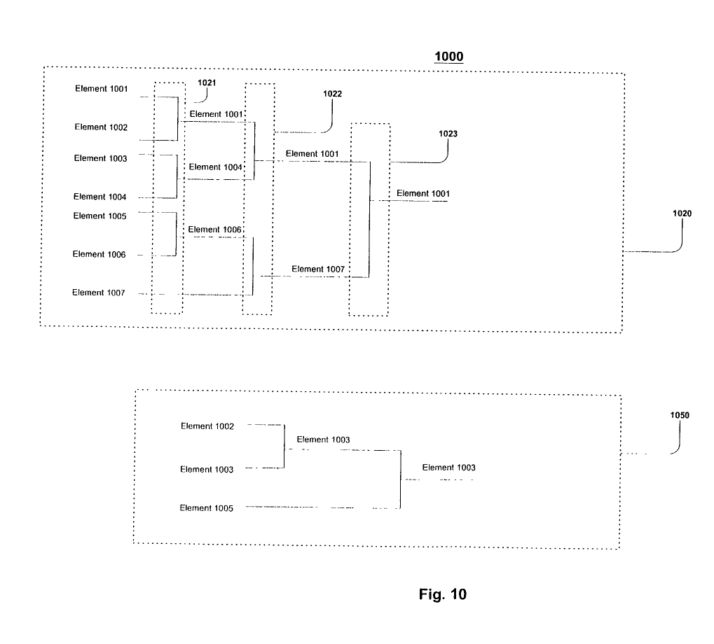

Referring to FIG. 10, a bracket diagram 1000 depicts how a set of polling requests on the bracket server may be structured in one implementation. The bracket diagram 1000 includes an original bracket 1020 designed to determine a most popular element among seven elements, and a follow up bracket 1050 that is designed to poll elements that were not selected in the first round 1021. Although only two brackets are depicted, more brackets are possible. For example, the elements that are not selected in the second round 1022 might be polled against one another.

Original bracket 1020 is a set of polling requests that polls seven elements to determine a most selected element. Bracket 1020 begins in first round 1021 by polling elements 1001-1006 against one another in groups of two, with element 1007 receiving a “bye”. Elements 1001, 1004, 1006 and 1007 emerge from round 1021. In the second round 1022, element 1001 is polled against element 1004 and element 1006 is polled against element 1007. Element 1001 and element 1007 emerge from round 1022. In the third and final round 1023, element 1001 is polled against element 1007, and element 1001 emerges as the most selected element from original bracket 1020.

A follow up bracket 1050 is an implementation of a bracket system of polling where the elements that did not emerge from round 1021 can be polled against one another. For example, elements 1002, 1003 and 1005 were not selected in round 1021 of bracket 1020. Element 1002 is polled against element 1003 with element 1005 being polled against the selected element from the element 1002/element 1003 poll.

In some implementations, the set of polling requests 1000 may logically resemble a bracket tree with 2^{N} leafs to the tree where N is the number of rounds in the polling request and there are two elements per polling request. However, the set of polling requests is not limited to a symmetrical bracket tree where every element must overcome the same number of elements and rounds to appear in a subsequent polling request. For example, element 1007 received a “bye” in round 1021. In another example, instead of receiving a bye in round 1021, element 1007 could have been polled against element 1005 and element 1006.

Implementations of determining the most selected element may include counting the relative number of interactive television viewers selecting one element over another element appearing in a polling request. For example, if 300 interactive television viewers select element A and 200 interactive television viewers select element B, then element A is the most selected element.

Implementations of determining the most selected element may include counting the number of votes received in a polling request for the element where each interactive television viewer may vote more than once. For example, in the above example, if 300 interactive television viewers select element A each voting once while 200 interactive television viewers select element B each voting twice, then element A receives 300 votes and element B receives 400 votes.

Other implementations are within the scope of the following claims. In particular, in some implementations, the client may perform one or more functions described above as being performed on the host. The client, host, and network also may be distributed across different entities in the communication system and make use of one or more agents and/or proxies to perform certain functions. For example, content may be provided by a different entity than the host transmitting the polling requests.

What is claimed is:

1. A method of polling interactive television viewers, the method comprising:
preparing a set of polling requests that each ask an interactive television viewer to select an element from a group of two or more elements;
connecting to one or more set top systems of one or more interactive television viewers;
sending the set of polling requests to the one or more set top systems of the one or more interactive television viewers;
receiving responses to the set of polling requests from one or more interactive television viewers;
evaluating the responses to the set of polling requests; and
preparing a new polling request including two or more elements selected based on the evaluation of the responses to the set of polling requests.

2. The method of claim 1 wherein two polling requests have two different sets of elements.

3. The method of claim 1 wherein each element appearing in the set of polling requests is different from the every other element appearing in the set of polling requests.

4. The method of claim 1 wherein evaluating the responses includes tallying the responses that have been received after a time limit.

5. The method of claim 4 wherein the time limit is applied relative to a period that begins when the polling request is initially displayed to an interactive television viewer.

6. The method of claim 4 wherein the time limit is common to all of the interactive television viewers.

7. The method of claim 1 further comprising displaying particular content to the interactive television viewers based on evaluating the responses.

8. The method of claim 7 wherein the particular content includes a graphical user interface.

9. The method of claim 7 wherein the particular content includes multimedia data.

10. The method of claim 7 wherein displaying particular content to the interactive television viewer comprises displaying the particular content using the set top system.

11. The method of claim 1 further comprising designating polling rules for targeting the interactive television viewers.

12. The method of claim 11 further comprising determining context information of interactive television viewers.

13. The method of claim 12 further comprising applying the targeting rules to the context information to identify targeted interactive television viewers.

14. The method of claim 12 wherein determining the context information includes determining television programming being viewed by an interactive television viewer at a particular time.

15. The method of claim 14 wherein determining television programming being viewed comprises determining the television programming tuned to by a set top box.

16. The method of claim 14 wherein determining television programming being viewed comprises determining the television programming using an EPG.

17. The method of claim 1 further comprising determining context information associated with television programming available for delivery to the interactive television viewer.

18. The method of claim 17 wherein determining the context information associated with the television programming comprises determining context information based upon a television signal received by a set top box.

19. The method of claim 17 wherein determining context information associated with the television programming comprises determining context information based upon a channel identification number.

20. The method of claim 17 wherein determining context information associated with the television programming comprises determining context information based upon a broadcaster identifier.

21. The method of 17 wherein preparing a set of polling requests includes preparing the polling requests based on context information associated with the television programming.

22. The method of claim 17 wherein determining context information associated with the television programming comprises determining context information based upon a television series.

23. The method of claim 17 wherein determining context information associated with the television programming comprises determining context information based upon an episode of a television show.

24. The method of claim 17 wherein determining context information associated with the television programming comprises determining context information based upon an EPG identity.

25. The method of claim 17 wherein determining context information associated with the television programming comprises determining context information based upon a program content category.

26. The method of claim 1 wherein sending the set of polling requests includes prompting the interactive television viewer to select one element in the polling request of two or more elements.

27. The method of claim 1 wherein sending the set of polling requests includes prompting an interactive television viewer to rank order a list of elements.

28. The method of claim 1 wherein determining two or more elements in the new polling request includes a most selected element in a first polling request and a most selected element in a second polling request.

29. The method of claim 28 wherein the set of polling requests continues until there is one element that has not been selected to a lesser degree than other elements in any polling request of the most selected elements and the other elements.

30. The method of claim 1 wherein evaluating the responses includes determining which element in the polling request received the most votes.

31. The method of claim 1 wherein determining two or more elements in the new polling request includes a least selected element in a first polling request and a least selected element in a second polling request.

32. The method of claim 1 wherein sending the set of polling requests includes sending an instant message.

33. The method of claim 1 wherein sending the set of polling requests includes sending an electronic mail message.

34. The method of claim 1 wherein sending the set of polling requests includes sending a display to overlay television programming.

35. A method of participating in an interactive television poll, the method comprising:
connecting to a host;
receiving a set of polling requests;
completing the polling requests;
transmitting the responses to the polling requests; and
receiving a new polling request including two or more elements selected based on the responses of one or more interactive television viewers to the set of polling requests.

36. A communications apparatus being for polling interactive television viewers, the apparatus configured to:
prepare a set of polling requests that each ask an interactive television viewer to select an element from a group of two or more elements;
connect to one or more set top systems of one or more interactive television viewers;
send the set of polling requests to the one or more set top systems of the one or more interactive television viewers;
receive responses to the set of polling requests from one or more interactive television viewers;
evaluate the responses to the set of polling requests; and
prepare a new polling request including two or more elements selected based on the evaluation of the responses to the set of polling requests.

37. A communications apparatus for participating in interactive television polling, the apparatus being configured to:
connect to a host;
receive a set of polling requests;
complete the polling requests;
transmit the responses to the set of polling requests; and
receive a new polling request including two or more elements selected based on the responses of one or more interactive television viewers to the set of polling requests.

38. A computer program for polling interactive television viewers, the computer program being stored on a computer readable medium and comprising instructions for causing a computer to:
prepare a set of polling requests that each ask an interactive television viewer to select an element from a group of two or more elements;
connect to one or more set top systems of one or more interactive television viewers;
send the set of polling requests to the one or more set top systems of the one or more interactive television viewers;
receive responses to the set of polling requests from one or more interactive television viewers;
evaluate the responses to the set of polling requests; and
prepare a new polling request including two or more elements selected based on the evaluation of the responses to the set of polling requests.

39. A computer program for participating in interactive television polling, the computer program being stored on a computer readable medium and comprising instructions for causing a computer to:
connect to a host;
receive a set of polling requests;
complete the polling requests;
transmit the responses to the polling requests; and
receive a new polling request including two or more elements selected based on the responses of one or more interactive television viewers to the set of polling requests.
